(19) United States
(12) Patent Application Publication
(10) Pub. No.: US 2006/0285081 A1
(43) Pub. Date: Dec. 21, 2006

(54) Portable rear projection apparatus for projection display

(75) Inventors: Joon-seok Moon, Yongin-si (KR); Sang-il Park, Seoul (KR); Alexel Borodouline, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/336,789

(22) Filed: Jan. 23, 2006

(30) Foreign Application Priority Data
Jun. 15, 2005 (KR) 10-2005-0051256

(51) Int. Cl. G03B 21/28

(52) U.S. Cl. 353/77

(57) ABSTRACT

A portable rear projection apparatus includes a lens element for magnifying an image projected from a projector, an aspherical mirror for reflecting the image magnified by the lens element to change a light path, a screen for displaying the image reflected from the aspherical mirror, and a movable screen support for supporting the screen.

### CROSS-REFERENCE TO RELATED PATENT APPLICATION

This application claims priority from Korean Patent Application No. 10-2005-0051256, filed on Jun. 15, 2005, in the Korean Intellectual Property Office, the disclosure of which is incorporated herein in its entirety by reference.

### BACKGROUND OF THE INVENTION

1. Field of the Invention

The present invention relates to a portable rear projection apparatus for a projection display and, more particularly, to a portable/detachable rear projection apparatus that can be detachably associated with a subminiature projector to project an image using a rear projection method.

2. Description of the Related Art

Generally, a projector is a device realizing a large-sized screen by projecting or reflecting illumination light on a micro display panel and enlarging and projecting the illumination light on a screen. In recent years, with the increase of the demand of a home theater and a large-sized display, the projector has been widely used as it is low in price compared with its superior aspect ratio.

Referring to FIG. 1 showing a typical projector, a projector 10 includes a light source 11, an optical system 12, a micro display panel 13, a projection lens 14, and a screen 15. The light irradiated from the light source 11 is directed to the display panel 13 with a uniform light distribution via the optical system 12. The micro display panel 13 has image information that will be projected to the screen 15. Therefore, the light which has passed through the micro display panel 13 contains an image. Then, the image is enlarged by the projection lens 14 and projected to the screen 15. Generally, the projector 10 is designed such that the micro display panel 13 and the projection lens 14 are offset from each other to project the image upward from a horizontal plane.

The projector can be classified into a front projection type and a rear projection type. The former is designed such that a viewer watches the image at a left side of the screen in the drawing. The latter is designed such that the viewer watches the mage at a right side of the screen in the drawing. Although the front projection type has an advantage of saving space as compared with the rear projection type, it has a disadvantage of providing a clear image only in a dark space. Also, a special space is required in rear of the screen for the rear projection type in order not to block an image. However, the rear projection type provides a clear image even when the surrounding space is not dark and no space is required in front of the screen.

A projection TV is basically identical in structure to the above-described projector, capable of saving a space in the rear of the screen by deflecting the light irradiated from the light source using a mirror.

Referring to FIG. 2 showing a typical projection TV, a projection TV 20 includes a light source 21, an optical system 22, a micro display panel 23, a projection lens 24, mirrors 25 and 26, and a screen 27. Similar to the projector 10 depicted in FIG. 1, the light irradiated from the light source 21 contains an image while passing through the optical system 22 and the micro display panel 23. Then, the light with the image is projected to the screen 27 after being deflected in an opposite direction through the mirrors 25 and 26. That is, the light path is converted in an opposite direction by the mirrors 25 and 26.

The projector 10 is designed to adjust a size of the image to a desired size by adjusting a projecting length. However, the projection TV 20 is designed to provide the image with the fixed size since a size of the set is limited. Therefore, in order to adjust the image size in the projection TV 20, the screen 27 fixed on the set must be displaced so that the viewer can watch the screen 27 through a front projection type. However, the displacement of the screen 27 fixed on the set is actually impossible and even when it is possible, the internal optical system 22 must be rearranged. The rearrangement of the optical system 22 is troublesome for the viewer who is not an expert in the field.

### SUMMARY OF THE INVENTION

The present invention provides a portable rear projection apparatus that can be used with a subminiature projector to project an image using a rear projection method.

According to one aspect of the present invention, there is provided a portable rear projection apparatus including: a lens element for magnifying an image projected from a projector; an aspherical mirror for reflecting the image magnified by the lens element to change a light path; a screen for displaying the image reflected from the aspherical mirror; and a movable screen support for supporting the screen.

The lens element and the aspherical mirror may be installed in a single housing and the screen support may have a first end pivotally coupled to the housing and a second end coupled to the screen.

The screen support may be formed of a telescopic rod to dispose the screen on the housing through telescopic and pivotal operations.

The screen may be formed of a roll screen to be rolled up when the screen is not in use.

The lens element may be one of a spherical lens and an aspherical lens and tilted.

According to another aspect of the present invention, there is provided a portable rear projection apparatus including: a first mirror for primarily changing a light path of an image projected from the projector; a second mirror for secondarily changing the light path of the image reflected from the first mirror; a screen for displaying the image reflected from the second mirror; and a movable screen support for supporting the screen.

The first mirror may be installed in a housing and the second mirror may be pivotally coupled to the housing to be disposed on the housing when not in use or erected from the housing when in use.

The screen support may have a first end pivotally coupled to one of the housing and the second mirror and a second end coupled to the screen.

The screen support may be formed of a telescopic rod to dispose the screen on the housing through telescopic and pivotal operations.

The screen may be formed of a roll screen to be rolled up when the screen is not in use.

Each of the first and second mirrors may be an aspherical mirror.

The portable/detachable rear projection apparatus may further include a lens element disposed in front of the first mirror in the housing.

An advancing direction of the image reflected from the first mirror may be identical to that of the image reflected from the second mirror in a horizontal component. Alternatively, an advancing direction of the image reflected from the first mirror may be opposite to that of the image reflected from the second mirror in the horizontal component.

### BRIEF DESCRIPTION OF THE DRAWINGS

The above and other features and advantages of the present invention will become more apparent by describing in detail exemplary embodiments thereof with reference to the attached drawings, in which:

FIG. 1 a schematic view of a conventional projector;

FIG. 2 is a schematic view of a conventional projection TV;

FIG. 3 is a schematic view of a portable/detachable rear projection apparatus according to a first embodiment of the present invention;

FIG. 4 is a schematic view of a portable/detachable rear projection apparatus according to a variation of the first embodiment of the present invention;

FIG. 5 is a schematic view of a portable/detachable rear projection apparatus according to a second embodiment of the present invention; and

FIG. 6 is a schematic view of a portable/detachable rear projection apparatus according to a third embodiment of the present invention.

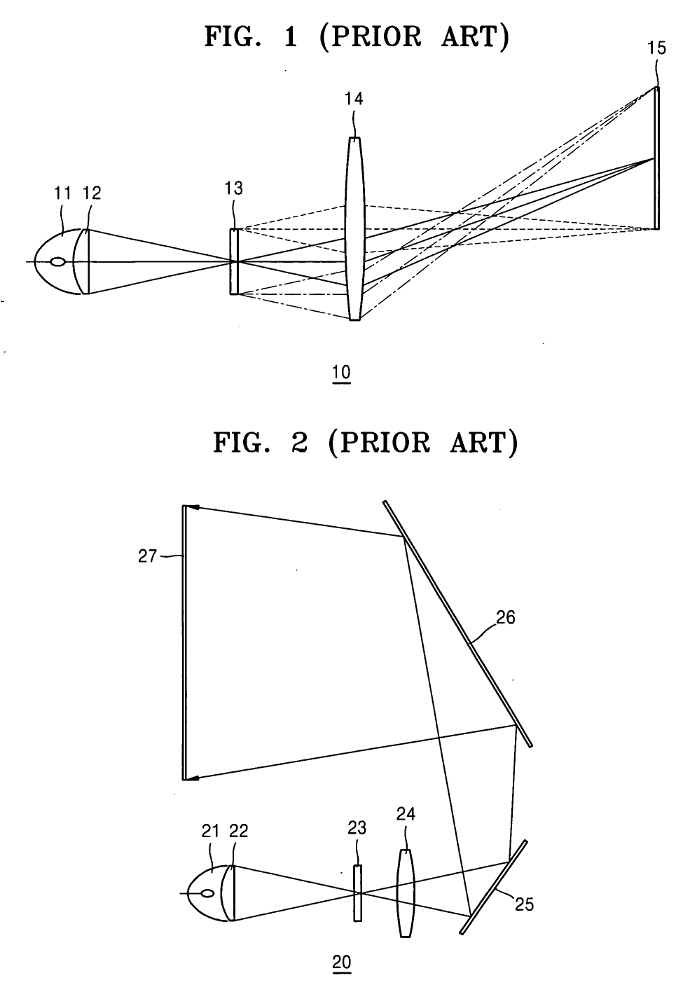

### DETAILED DESCRIPTION OF THE INVENTION

The present invention will now be described more fully with reference to the accompanying drawings, in which exemplary embodiments of the invention are shown.

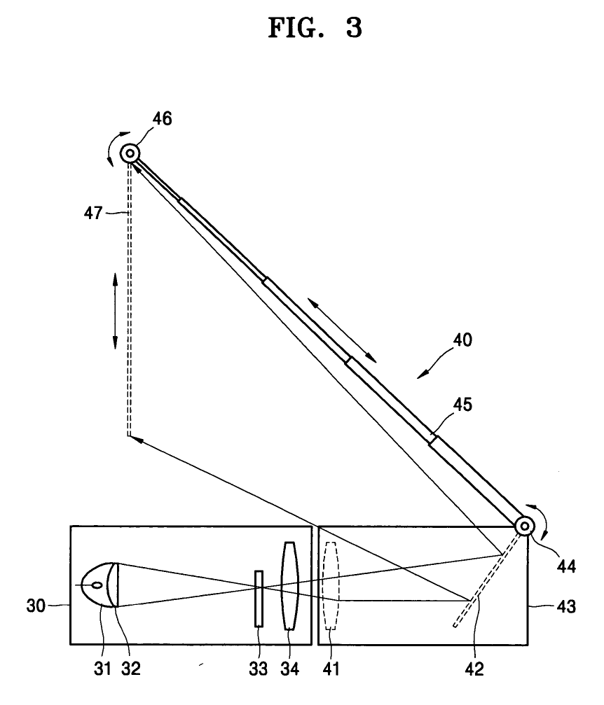

FIG. 3 shows a portable/detachable rear projection apparatus according to a first embodiment of the present invention.

Referring to FIG. 3, a portable/detachable rear projection apparatus 40 is a rear projection type that is disposed in front of a projector 30 to project an image from the projector 30 to a screen using a rear projection method. The portable/detachable rear projection apparatus 40 includes a lens element 41 for magnifying an image from the projector 30, an aspherical mirror 42 for reflecting the magnified image to change a light path, a screen 47 on which the reflected image is displayed, and a screen support 45 for supporting the screen 47.

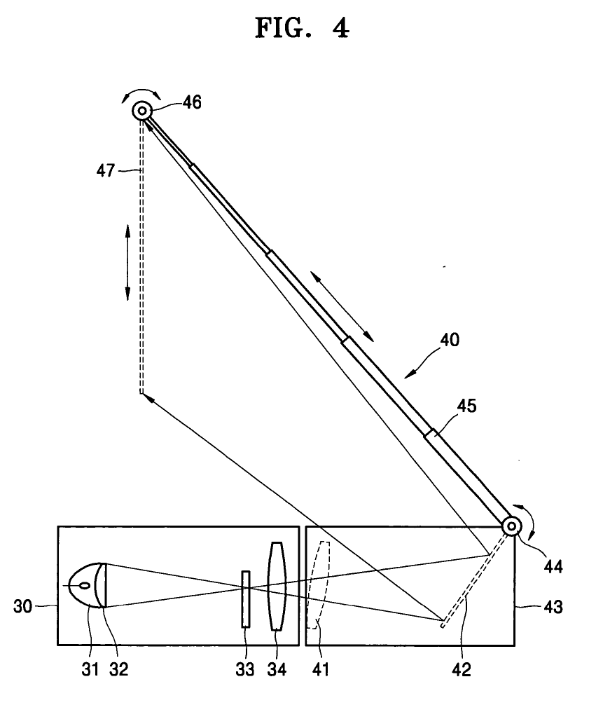

The light irradiated from a light source 31 of the projector 30 contains image information while passing through an optical system 32 and a micro display panel 33 and to be projected from the projector 30 through a projection lens 34. The image projected from the projector 30 is enlarged by the lens element 41 of the projection apparatus 40 and is then directed to the aspherical mirror 42. A spherical convex lens may be used as the lens element 41. However, when the spherical convex lens is used, chromatic aberration may occur, causing the image displayed on the screen to be distorted. Therefore, it is preferable, but not necessary, that an aspherical convex lens is used as the lens element. More preferably, a lens group comprised of a plurality of lenses may be used. In addition, to prevent the image on the screen from deforming into a trapezoid shape, as shown in FIG. 4, it is also possible to tilt the lens element at a predetermined angle. The image directed to the aspherical mirror 42 is, as shown in FIG. 3, reflected thereon to change the light path in an opposite upward direction. Then, the image is projected to a rear surface of the screen 47. The viewer watches the image, which is projected to the rear surface, at a location in front of the screen 47.

As described above, since the rear projection apparatus 40 of this embodiment projects the image from the projector 30 to the screen using the rear projection method, the viewer can watch a clean image in a well-lit room and even in the bright light of the outdoors. In addition, since the image can be adjusted by adjusting a focus ring or zoom of the projector or by adjusting an installing location and angle after the rear projection apparatus 40 is installed just in front of the projector 30, it is very convenient for the user. Therefore, the rear projection apparatus 40 can be installed even in a small space since there is less space restriction in installing the same. Particularly, when the rear projection apparatus 40 is associated with a subminiature projector that is smaller in a size than a laptop computer, it is possible to watch the image in a state where the projector/apparatus assembly is installed on a small desk. For example, the screen 47 may be designed in a size of 30 cm×30 cm. That is, since the subminiature projector and the rear projection apparatus 40 are handy to carry, the user can give a presentation whenever and wherever he wants.

Therefore, there is a need to design the rear projection apparatus 40 to be handier. Referring to FIG. 3, the lens element 41 and the aspherical mirror 42 are installed in a single housing 43. A first end of the screen support 45 is pivotally coupled to the housing 43 by a hinge 44. The screen support 45 can be pivoted to an erected position when in use and be pivoted to a lay-down position on the housing 43 when not in use. The screen support 45 may be designed to be adjustable in a length. For example, the screen support 45 may be formed in a boom structure that is expandable. That is, the screen support 45 may be formed of a telescopic rod that can be adjustable in the length. In this case, the screen 47 may be disposed on the housing by the telescopic and pivotal operations of the screen support 45. Alternatively, the screen support 45 may be formed of a plurality of rods that are connected to each other by a link structure.

Meanwhile, the screen 47 may be a roll screen and a roller 46 may be installed on a second end of the screen support 45 to roll and unroll the screen 47. In this case, after the use of the rear projection apparatus 40, the screen is rolled up and disposed on the housing 43, thereby saving space and protecting the screen.

In use, the rear projection apparatus 40 is in a state as depicted in FIG. 3. After the use, the screen 47 and the screen support 45 are folded on the housing 43. Therefore, it is very convenient to install and carry the rear projection apparatus 40.

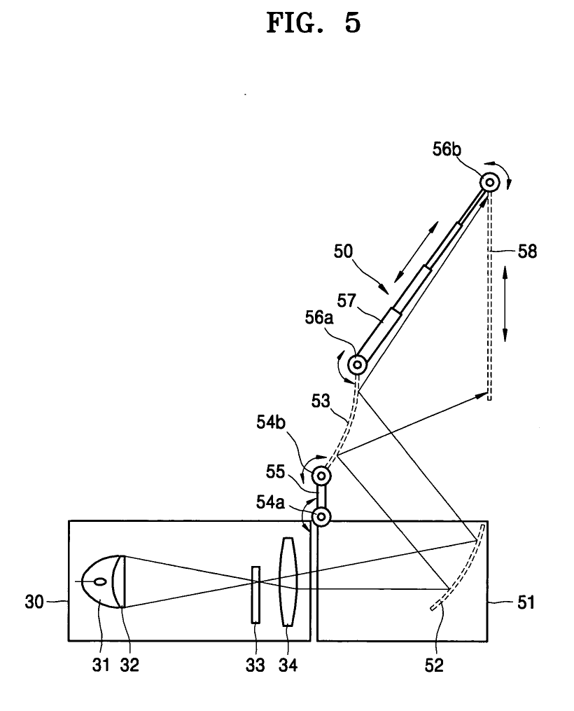

FIG. 5 shows a portable/detachable rear projection apparatus according to a second embodiment of the present invention.

As shown in FIG. 5, a portable/detachable rear projection apparatus 50 of this embodiment includes a first mirror 52 for reflecting an image projected from the projector 30 to primarily change a light path of the image, a second mirror 53 for reflecting the image reflected from the first mirror 52 to secondarily change the light path of the image, a screen 58 for displaying the image reflected from the second mirror 53, and a screen support 57 for supporting the screen 58. The first and second mirrors 52 and 53 may be formed of an aspherical mirror to magnify the image and prevent the generation of an aberration and the distortion of the image.

The image projected from the projector 30 is reflected by the first mirror 52 to primarily change the light path. This primarily changed light path is secondarily changed by the second mirror 53, after which the image is projected to a rear surface of the screen so that the viewer can watch the image in front of the screen 58. As shown in FIG. 5, the light path of the image reflected from the first mirror 52 is upwardly changed in a direction opposite to that where the image is projected from the projector. The light path of the image reflected from the second mirror 53 is horizontally reflected in a direction opposite to the reflection direction by the first mirror 52. At a result, a final projection direction of the image is to be identical to that where the image is projected from the projector 30. However, the first and second mirrors 52 and 53 may be arranged such that the image reflected from the first mirror 52 can be horizontally reflected by the second mirror 53 in a direction opposite to that where the image is projected from the projector 30 as in FIG. 2.

For portability, the second mirror 53, the screen 58 and the screen support 57 may be designed to be folded on the housing 51. To realize this, the first mirror 52 is installed in the housing 51 while the second mirror 53 is pivotally coupled to the housing 51 so that it can be folded on the housing or erected from the housing 51. The second mirror 53 may be coupled to the housing 51 by a single hinge or by a rod 55 provided with hinges 54a and 54b to provide a space for receiving the screen 58 and the screen support 57. The screen support 57 is pivotally coupled the second mirror 53 by a hinge 56a. Alternatively, the screen support 57 may be pivotally coupled to the housing 51.

As in the first embodiment, the screen support 57 may be formed of a telescopic rod that can be adjustable in the length. Alternatively, the screen support 57 may be formed of a plurality of rods that are connected to each other by a link structure. In addition, the screen 58 may be a roll screen and a roller 56b may be installed on an end of the screen support 57 to roll and unroll the screen 58.

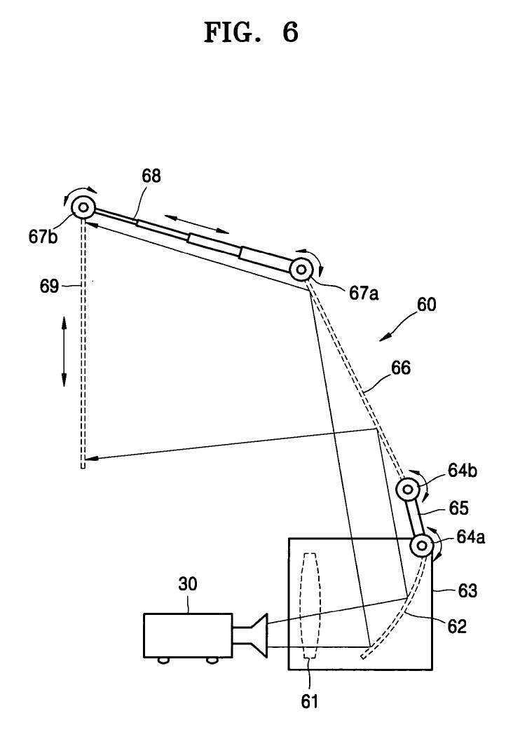

FIG. 6 shows a portable/detachable rear projection apparatus according to a third embodiment of the present invention.

This embodiment is actually identical to the second embodiment except that a lens element 61 magnifying an image projected from a projector 30 is disposed in front of a first mirror 62 in a housing 63. In this case, the lens element 61 may be formed of a spherical convex lens or preferably of an aspherical convex lens. Since the lens element 61 is additionally provided, there is no need to form the first and second mirror 62 and 66 with an aspherical mirror. Particularly, the second mirror 66 may be formed of a flat mirror. However, it is preferable that the first mirror 62 is formed of an aspherical mirror to prevent the generation of an aberration and the distortion of the image.

As shown in FIG. 6, the first and second mirrors 62 and 66 are arranged such that the image reflected from the first mirror 62 can be horizontally reflected by the second mirror 66 in a direction opposite to that where the image is projected from the projector 30. Alternatively, similar to FIG. 5, the first and second mirrors 62 and 66 may be arranged such that the image projected from the projector 30 is reflected from the first mirror 62 at a predetermined angle and is then further reflected by the second mirror 66 in a direction opposite to that where the image is reflected by the first mirror 61.

As in the second embodiment, for portability, the second mirror 66, the screen 69 and the screen support 68 may be designed to be folded on the housing 63. To realize this, the second mirror 66 may be coupled to the housing 63 by a single hinge or by a rod 65 provided with hinges 64a and 64b to provide a space for receiving the screen 69 and the screen support 68. The screen support 68 is pivotally coupled the second mirror 66 by a hinge 67a. Alternatively, the screen support 68 may be pivotally coupled to the housing 63. In addition, the screen support 68 may be formed of a telescopic rod so that it can be adjustable in the * length. Alternatively, the screen support 68 may be formed of a plurality of rods that are connected to each other by a link structure. In addition, the screen 69 may be a roll screen and a roller 67b may be installed on an end of the screen support 68 to roll and unroll the screen 69.

According to the present invention, since the rear projection apparatus of this embodiment projects the image from the projector to the screen using the rear projection method, the viewer can watch a clean image in a well-lit room and even in the bright light of the outdoors. In addition, since the image can be adjusted by adjusting a focus ring or zoom of the projector or by adjusting an installing location and angle after the rear projection apparatus is installed just in front of the projector, it is very convenient for the user. Therefore, the rear projection apparatus can be installed even in a small space since there is less space restriction in installing the same. Particularly, when the rear projection apparatus is associated with a subminiature projector that is smaller in a size than a laptop computer, it is possible to watch the image in a state where the projector/apparatus assembly is installed on a small desk.

In addition, since the subminiature projector and the rear projection apparatus are handy to carry, the user can give a presentation whenever and wherever he wants.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A portable rear projection apparatus comprising:
a lens element for magnifying an image projected from a projector;
an aspherical mirror for reflecting the image magnified by the lens element to change a light path;
a screen for displaying the image reflected from the aspherical mirror; and
a movable screen support for supporting the screen.

2. The portable rear projection apparatus of claim 1, wherein the lens element and the aspherical mirror are installed in a single housing; and
the screen support has a first end pivotally coupled to the housing and a second end coupled to the screen.

3. The portable rear projection apparatus of claim 2, wherein the screen support is formed of a telescopic rod to dispose the screen on the housing through telescopic and pivotal operations.

4. The portable rear projection apparatus of claim 3, wherein the screen is formed of a roll screen to be rolled up when the screen is not in use.

5. The portable rear projection apparatus of claim 1, wherein the lens element is one of a spherical lens and an aspherical lens.

6. The portable rear projection apparatus of claim 5, wherein the lens element is tilted.

7. A portable rear projection apparatus comprising:
a first mirror for primarily changing a light path of an image projected from a projector;
a second mirror for secondarily changing the light path of the image reflected from the first mirror;
a screen for displaying the image reflected from the second mirror; and
a movable screen support for supporting the screen.

8. The portable rear projection apparatus of claim 7, wherein the first mirror is installed in a housing; and
the second mirror is pivotally coupled to the housing to be disposed on the housing when not in use or erected from the housing when in use.

9. The portable rear projection apparatus of claim 8, wherein the screen support has a first end pivotally coupled to one of the housing and the second mirror and a second end coupled to the screen.

10. The portable rear projection apparatus of claim 9, wherein the screen support is formed of a telescopic rod to dispose the screen on the housing through telescopic and pivotal operations.

11. The portable rear projection apparatus of claim 10, wherein the screen is formed of a roll screen to be rolled up when the screen is not in use.

12. The portable rear projection apparatus of claim 7, wherein each of the first and second mirrors is an aspherical mirror.

13. The portable rear projection apparatus of claim 7, further comprising a lens element disposed in front of the first mirror in the housing.

14. The portable rear projection apparatus of claim 7, wherein an advancing direction of the image reflected from the first mirror is identical to that of the image reflected from the second mirror in a horizontal component.

15. The portable rear projection apparatus of claim 7, wherein an advancing direction of the image reflected from the first mirror is opposite to that of the image reflected from the second mirror in a horizontal component.
